(19) United States
(12) Patent Application Publication
(10) Pub. No.: US 2009/0075096 A1
(43) Pub. Date: Mar. 19, 2009

(54) Organoalkoxysilanes

(75) Inventors: Pierre-Andre Butikofer, Wallisellen (CH); Barbara Jucker, Zurich (CH); Urs Burckhardt, Zurich (CH); Ueli Pfenninger, Au (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/149,561

(22) Filed: May 5, 2008

Related U.S. Application Data
(63) Continuation of application No. 11/896,057, filed on Aug. 29, 2007, now abandoned.
Application No. 11/896,057 is a continuation of application No. 11/645,065, filed on Dec. 26, 2006, now abandoned.
Application No. 11/645,065 is a continuation of application No. 11/414,385, filed on May 1, 2006, now abandoned.

(30) Foreign Application Priority Data
Apr. 29, 2005 (EP) 05103562.4

(51) Int. Cl. B32B 9/00; C07F 7/10; C08K 5/5455

(52) U.S. Cl. 428/447; 556/419; 556/421; 524/188

(57) ABSTRACT

The present invention relates to organoalkoxysilanes containing a urea or thiourea or carbamate or thiocarbamate group of formula (I), as well as preparation and use thereof. It further relates to a composition containing the organoalkoxysilane of formula (I). Such compositions are especially suitable as adhesives and sealants, and have high stretchability and high strength.

This is a Continuation of application Ser. No. 11/896,057 filed Aug. 29, 2007 which is a Continuation of application Ser. No. 11/645,065 filed Dec. 26, 2006, which is a Continuation of application Ser. No. 11/414,385 filed May 1, 2006. The disclosure of the prior applications are hereby incorporated by reference herein in their entireties.

### BACKGROUND

The disclosure relates to organoalkoxysilanes containing a urea or thiourea or carbamate or thiocarbamate group, a method for their preparation, their use as components of compositions, as well as moisture-curing compositions containing at least one organoalkoxysilane and at least one silane-functional and/or isocyanate-functional polymer, suitable in particular as adhesives, sealants, or coatings with good mechanical properties.

Organoalkoxysilanes are known inter alia as additives for compositions, for example as adhesion promoters, such as described in Handbook of Coatings Additives, L. J. Calbo, ed., M. Dekker Inc. (1987), Chapter 10, pages 281-294.

In U.S. Pat. No. 5,384,342 and U.S. Pat. No. 6,441,213, organoalkoxysilanes are described that contain a urea or thiourea group and that are suitable, for example, as adhesion promoters in polymers containing polymerizable double bonds. These organoalkoxysilanes contain a reactive organic group with at least one activated double bond.

Compositions based on silane-functional and/or isocyanate-functional polymers are known, and are used inter alia as moisture-curing adhesives, sealants, and coatings. For most of these applications, for example joint sealants or mounting adhesives, it is crucial for the composition to have both adhesion properties and good mechanical properties in the cured state, where it is especially important to simultaneously have high stretchability and high tear strength. These requirements are often not met by such compositions, in particular those based on silane-functional polymers.

The use of organoalkoxysilanes in moisture-curing compositions based on silane-functional and/or isocyanate-functional polymers is known. They are typically used to specifically affect properties such as adhesion, stability in storage, and reactivity, as described, for example, in U.S. Pat. No. 3,979,344, U.S. Pat. No. 5,147,927, U.S. Pat. No. 6,703,453, and EP 0 819 749 A2. However, the improvements achieved in the systems according to the prior art with respect to mechanical properties, in particular stretchability and tear strength, are usually modest and insufficient for many applications.

### SUMMARY

This disclosure provides novel organoalkoxysilanes, as well as methods for their preparation and use. An essential feature of the organoalkoxysilanes of exemplary embodiments is that they contain a urea, thiourea, carbamate, or thiocarbamate group. Another essential feature of exemplary embodiments is that they do not contain any other groups, besides the silane groups, which enter into polymerization reactions. The organoalkoxysilanes of exemplary embodiments can be obtained from reaction of suitable aminosilanes, mercaptosilanes, or hydroxysilanes with monoisocyanates or monoisothiocyanates.

The organoalkoxysilanes of exemplary embodiments can be used in many different ways as components of compositions such as primers, paints, lacquers, adhesives, sealants, and floor coverings, for example as adhesion promoters, drying agents, crosslinkers, or reactive diluents. In particular embodiments, the organoalkoxysilanes can be used in moisture-curing compositions based on silane-functional and/or isocyanate-functional polymers. It was surprisingly found that moisture-curing compositions containing at least one organoalkoxysilane of embodiments and at least one silane-functional polymer have, in the cured state, high stretchability and at the same time high tear strength, and therefore are especially suitable for use as adhesives, sealants, or coatings.

### DETAILED DESCRIPTION OF EMBODIMENTS

The present disclosure relates, in embodiments, to organoalkoxysilanes containing a urea, thiourea, carbamate, or thiocarbamate group of formula (I),

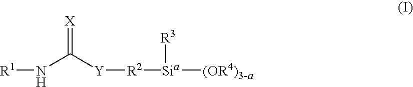

in which R¹ represents a group selected from alkyl, cycloalkyl, aryl, and arylalkyl groups, which optionally may be substituted and/or contain heteroatoms, and which does not contain any groups that react with water, silane, amino groups or polymerizable double bonds, R² represents a linear or branched, optionally cyclic alkylene group with 1 to 20 C atoms, optionally with aromatic moieties and optionally containing heteroatoms, R³ represents an alkyl group with 1 to 8 C atoms, such as a methyl group or an ethyl group, in particular a methyl group, R⁴ represents an alkyl group with 1 to 5 C atoms, such as a methyl group, an ethyl group or an isopropyl group, in particular a methyl group or an ethyl group, a represents 0, 1, or 2, such as 0 or 1, X represents O or S, and Y represents O, S, or N—R⁵, wherein R⁵ represents a linear or branched hydrocarbon residue with 1 to 20 C atoms, which optionally has cyclic moieties and which optionally has at least one functional group selected from the group consisting of alkoxysilyl, ether, sulfone, nitrile, nitro, carboxylic acid ester, sulfonic acid ester, and phosphonic acid ester groups.

The present disclosure also relates, in embodiments, to moisture-curing compositions, containing at least one silane of formula (I), suitable as adhesives, sealants, or coatings.

In embodiments, the disclosure relates to moisture-curing compositions containing at least one silane-functional polymer and at least one silane of formula (I), suitable in particular as adhesives, sealants, or coatings with good mechanical properties, in particular high stretchability.

Herein, the term “polymer” includes, on the one hand, a group of chemically uniform macromolecules that, however, may have different degrees of polymerization, molecular weights, and chain lengths, that have been synthesized by means of a polyreaction (polymerization, polyaddition, polycondensation). The term also includes, on the other hand, derivatives of such a group of macromolecules from polyreactions, and therefore compounds that have been obtained by reactions such as addition or substitution reactions involving functional groups on the specified macromolecules and that can be chemically uniform or chemically nonuniform. The term also includes “prepolymers,” i.e., reactive oligomeric pre-adducts with functional groups that take part in synthesis of the macromolecules.

The term “polyurethane polymer” includes all polymers that are synthesized by the diisocyanate polyaddition process. This includes such polymers that are nearly or completely free of urethane groups, such as polyether polyurethanes, polyester polyurethanes, polyether polyureas, polyureas, polyester polyureas, polyisocyanurates, polycarbodiimides, etc.

Herein, the term “organoalkoxysilane,” or “silane” for short, refer to compounds in which at least one, usually two or three alkoxy groups are bonded directly to the silicon atom (through a Si—O bond) and that have at least one organic residue directly bonded to the silicon atom (through a Si—C bond). Accordingly, the term “silane group” means the silicon-containing group bonded to the organic residue of the organoalkoxysilane. The organoalkoxysilanes, or their silane groups, undergo hydrolysis when in contact with moisture. Organosilanols are thus formed, i.e., organosilicon compounds containing one or more silanol groups (Si—OH groups) and, by means of subsequent condensation reactions, organosiloxanes are formed, i.e., organosilicon compounds containing one or more siloxane groups (Si—O—Si groups).

Terms such as “aminosilane,” “isocyanatosilane,” and “mercaptosilane” mean silanes that have the corresponding functional groups, and therefore here an aminoalkyl alkoxysilane, an isocyanatoalkyl alkoxysilane, and a mercaptoalkyl alkoxysilane.

The term “silane-functional” means compounds, in particular polymers, that have silane groups.

In exemplary embodiments, organoalkoxysilanes of formula (I), called “silanes (I)” below, may contain a urea or a thiourea group and have formula (II),

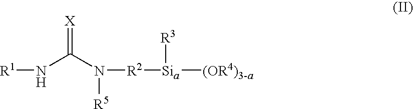

in which R¹, R², R³, R⁴, R⁵, X, and a have the meanings indicated above for formula (I), and in which R⁵ is selected from the group consisting of methyl groups, ethyl groups, butyl groups, cyclohexyl groups, phenyl groups and residues of formula (III),

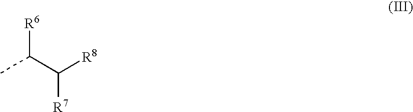

in which R⁶ and R⁷ each independently represent a hydrogen atom or a residue selected from the group consisting of R⁹, —COOR⁹, and —CN; and R⁸ represents a hydrogen atom or a residue selected from the group consisting of —CH₂—COOR⁹, —COOR⁹, —CN, —NO₂, —PO(OR⁹)₂, —SO₂R⁹, and —SO₂OR⁹; in which R⁹ represents a hydrocarbon residue with 1 to 20 C atoms, optionally containing at least one heteroatom. The dashed line in formula (III) represents the linkage with the nitrogen atom.

In embodiments, the substituents in formula (I) may be selected as follows: R⁶ represents —COOR⁹, R⁷ represents H, R⁸ represents —COOR⁹, and R⁹ represents an optionally branched alkyl group with 1 to 8 C atoms.

In embodiments, the silanes (I) may have formula (IV):

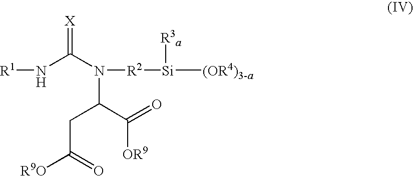

in which R¹ is chosen from the group consisting of ethyl, butyl, cyclohexyl, and phenyl groups; R² is chosen from the group consisting of methylene, propylene, butylene, methylpropylene, and dimethylbutylene groups; and R⁹ is chosen from the group consisting of methyl, ethyl, and butyl groups, and in which X, R³, R⁴, and a have the meanings already discussed for formula (I).

The silanes (I) of embodiments may be obtained, for example, by reaction of silanes of formula (V) with monoisocyanates or monoisothiocyanates of formula (VI)

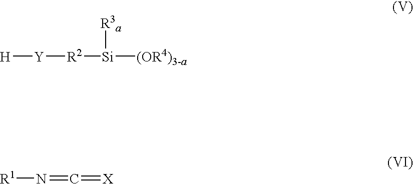

in which the substituents R¹, R², R³, R⁴, X, Y and a have the meanings already indicated.

The reaction is carried out with exclusion of moisture, for example at temperatures between 20° C. and 100° C., where optionally a suitable catalyst is added.

Suitable silanes of formula (V) for this reaction include:
mercaptosilanes, such as 3-mercaptopropyl trimethoxysilane, 3-mercaptopropyl dimethoxymethylsilane, as well as their analogs with ethoxy or isopropoxy groups instead of methoxy groups on the silicon;
hydroxysilanes, such as 3-hydroxypropyl trimethoxysilane, 3-hydroxypropyl dimethoxymethylsilane, as well as their analogs with ethoxy or isopropoxy groups instead of methoxy groups on the silicon;
aminosilanes of formula (VII) with a secondary amino group,

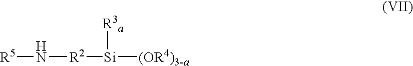

in which R², R³, R⁴, R⁵ and a have the meanings already described.

Suitable aminosilanes of formula (VII) for use in embodiments include aminosilanes derived from commercially available aminosilanes with a primary amino group, called “primary aminosilanes” in the following, such as for example 3-aminopropyl trimethoxysilane, 3-aminopropyl dimethoxymethylsilane, 3-amino-2-methylpropyl trimethoxysilane, 4-aminobutyl trimethoxysilane, 4-aminobutyl dimethoxymethylsilane, 4-amino-3-methylbutyl trimethoxysilane, 4-amino-3,3-dimethylbutyl trimethoxysilane, 4-amino-3,3-dimethylbutyl dimethoxymethylsilane, 2-aminoethyl trimethoxysilane, 2-aminoethyl dimethoxymethylsilane, aminomethyl trimethoxysilane, aminomethyl dimethoxymethylsilane, aminomethyl methoxydimethylsilane, 7-amino-4-oxaheptyl dimethoxymethylsilane, as well as their analogs with ethoxy or isopropoxy groups instead of methoxy groups on the silicon. Suitable aminosilanes of formula (VII) of embodiments include, for example, the derivatives of the exemplary primary aminosilanes which have a hydrocarbon residue such as a methyl, ethyl, butyl, cyclohexyl, or phenyl group on the nitrogen atom; secondary aminosilanes with multiple silane functional groups, such as for example bis(trimethoxysilylpropyl)amine; as well as the products of Michael addition of the exemplary primary aminosilanes to Michael acceptors such as maleic acid diesters, fumaric acid diesters, citraconic acid diesters, acrylic acid esters, methacrylic acid esters, cinnamic acid esters, itaconic acid diesters, vinylphosphonic acid diesters, vinylsulfonic aryl esters, vinylsulfones, vinylnitriles, 1-nitroethylenes or Knoevenagel condensation products such as, for example, those formed from malonic acid diesters and aldehydes such as formaldehyde, acetaldehyde, or benzaldehyde.

Especially suitable aminosilanes of formula (VII) for use in embodiments include N-methyl-3-aminopropyl trimethoxysilane, N-methyl-3-aminopropyl dimethoxymethylsilane, N-ethyl-3-amino-2-methylpropyl trimethoxysilane, N-ethyl-3-amino-2-methylpropyl dimethoxymethylsilane, N-butyl-3-aminopropyl trimethoxysilane, N-butyl-3-aminopropyl dimethoxymethylsilane, N-butyl-4-amino-3,3-dimethylbutyl trimethoxysilane, N-butyl-4-amino-3,3-dimethylbutyl dimethoxymethylsilane, N-cyclohexyl-3-aminopropyl trimethoxysilane, N-cyclohexyl-3-aminopropyl dimethoxymethylsilane, N-phenyl-3-aminopropyl trimethoxysilane, N-cyclohexyl aminomethyl trimethoxysilane, N-phenyl aminomethyl trimethoxysilane, N-phenyl aminomethyl dimethoxymethylsilane, the products of Michael addition of 3-aminopropyl trimethoxysilane, 3-aminopropyl dimethoxymethylsilane, 4-amino-3,3-dimethylbutyl trimethoxysilane, 4-amino-3,3-dimethylbutyl dimethoxymethylsilane, aminomethyl trimethoxysilane, or aminomethyl dimethoxymethylsilane to maleic acid dimethyl, diethyl, or dibutyl ester, acrylic acid tetrahydrofuryl, isobornyl, hexyl, lauryl, stearyl, 2-hydroxyethyl, or 3-hydroxypropyl ester, phosphonic acid dimethyl, diethyl, or dibutyl ester, acrylonitrile, 2-pentenenitrile, fumaronitrile, or β-nitrostyrene, as well as the analogs of the indicated aminosilanes with ethoxy groups instead of methoxy groups on the silicon.

Suitable monoisocyanates as in formula (VI) may include, for example, methyl isocyanate, ethyl isocyanate, n-butyl isocyanate, n-hexyl isocyanate, cyclohexyl isocyanate, phenyl isocyanate, as well as other commercially available monoisocyanates, as well as products of reactions of diisocyanates such as, for example, 2,4-toluoylene diisocyanate, with monoalcohols such as, for example, alkyl alcohols, reacted in a 1 to 1 mole ratio.

Suitable monoisothiocyanates as in formula (VI) may include, for example, methyl isothiocyanate, ethyl isothiocyanate, n-butyl isothiocyanate, n-hexyl isothiocyanate, cyclohexyl isothiocyanate, phenyl isothiocyanate, and other commercially available monoisothiocyanates.

In exemplary embodiments, the silanes (I) are stable when stored away from water. The alkoxy groups undergo hydrolysis when they come in contact with moisture. Organosilanols are thus formed (organosilicon compounds containing one or more silanol groups, Si—OH groups) and, by means of subsequent condensation reactions, organosiloxanes are formed (organosilicon compounds containing one or more siloxane groups, Si—O—Si groups).

The silanes of formula (I) of embodiments have two important structural features. First, they contain a carbamate or thiocarbamate group or a trisubstituted urea or thiourea group, which means that the silanes (I) also have a relatively low vapor pressure even with low molecular weight. Nevertheless, the presence of these groups (in contrast, for example, to disubstituted urea groups) does not lead to high viscosity or high melting points. Second, the silanes (I) do not contain any other groups, besides the silane groups, that enter into polymerization reactions, such as for example activated C═C double bonds. This fundamentally distinguishes them from the silanes mentioned in U.S. Pat. No. 5,384,342 and U.S. Pat. No. 6,441,213.

Because of their properties, the silanes (I) of embodiments are suitable as additives for a broad range of compositions, in particular polymer-containing compositions. For example, they can be used as adhesion promoters, drying agents, crosslinkers, or reactive diluents in compositions such as primers, paints, lacquers, adhesives, sealants, and floor coverings. They can also be used for sol-gel processes.

Silanes (I) of embodiments may be especially suitable as additives for moisture-curing compositions based on silane-functional and/or isocyanate-functional polymers.

Silanes (I) of embodiments may be particularly suitable as additives for moisture-curing compositions based on silane-functional polymers, where they can result in significant improvements in the mechanical properties, for example increased stretchability.

Additional embodiments of the present disclosure include moisture-curing compositions containing at least one silane of formula (I) and at least one silane-functional and/or isocyanate-functional polymer P. These compositions are especially suitable as adhesives, sealants, or coatings with good mechanical properties. Silane (I) is typically present in embodiments of such compositions in an amount of 0.5-40 wt. %, such as 2-30 wt. %, or 4-20 wt. %, relative to the total weight of the polymer in the composition.

The silane-functional and/or isocyanate-functional polymer P may represent the following polymers:

(i) an isocyanate-functional polyurethane polymer P1,

(ii) a polyurethane polymer P2 containing both silane and isocyanate groups,

(iii) a silane-functional polyurethane polymer P3,

(iv) a silane-functional polymer P4,

(v) a silane-functional polymer P5, or

mixtures of the indicated polymers.

In one embodiment, the polymer P may be an isocyanate-functional polyurethane polymer P1, which may be obtained by reaction of at least one polyisocyanate with at least one polyol.

This reaction may be carried out so that the polyol and the polyisocyanate are reacted by a conventional procedure, such as for example at temperatures from 50° C. to 100° C., optionally using suitable catalysts, where the polyisocyanate is measured out so that its isocyanate groups are present in stoichiometric excess relative to the hydroxyl groups of the polyol.

For example, the following commercially available polyols or any mixtures thereof may be used as polyols to make the isocyanate-functional polyurethane polymer P1:
Polyoxyalkylene polyols, also called polyether polyols, which are polymerization products of ethylene oxide, 1,2-propylene oxide, 1,2- or 2,3-butylene oxide, tetrahydrofuran or mixtures thereof, optionally polymerized using an initiator molecule with two or more active hydrogen atoms such as, for example, water, ammonia, or compounds with several OH or NH groups such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, and undecanediols, 1,3- and 1,4-cyclohexanedimethanol, bisphenol A, hydrogenated bisphenol A, 1,1,1-trimethylolethane, 1,1,1-trimethylolpropane, glycerol, aniline, as well as mixtures of the aforementioned compounds. Polyoxyalkylene polyols that have a low degree of unsaturation (measured according to ASTM D-2849-69 and expressed in milliequivalents of unsaturation per gram polyol (meq/g)) may be used; these may be synthesized, for example, using “double metal cyanide complex catalysts” (DMC catalysts), as well as polyoxyalkylene polyols with a higher degree of unsaturation, or synthesized, for example, using anionic catalysts such as NaOH, KOH, CsOH, or alkali metal alkoxides.

Polyoxyalkylene diols or polyoxyalkylene triols, in particular polyoxypropylene diols or polyoxypropylene triols, are especially suitable for use in embodiments.

Especially suitable polyoxyalkylene diols or polyoxyalkylene triols for use in exemplary embodiments are those having a degree of unsaturation below 0.02 meq/g and a molecular weight in the range from 1000 to 30 000 g/mol, as well as polyoxypropylene diols and triols with a molecular weight from 400 to 8000 g/mol. Herein, the term “molecular weight” means the average molecular weight Mₙ.

“EO-endcapped” (ethylene oxide-endcapped) polyoxypropylene diols or triols are also especially suitable for use in embodiments. The latter are special polyoxypropylene polyoxyethylene polyols that can be obtained, for example, by alkoxylating pure polyoxypropylene polyols with ethylene oxide, after completion of polypropoxylation, and thus have primary hydroxyl groups.
Styrene-acrylonitrile-grafted polyether polyols, such as supplied, for example, by Bayer under the name LUPRANOL.
Polyester polyols, synthesized for example from dihydric or trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols, reacted with organic dicarboxylic acids or their anhydrides or esters such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid or mixtures of the aforementioned acids, as well as polyester polyols derived from lactones such as, for example, ε-caprolactone.
Polycarbonate polyols, as can be obtained, for example, by reaction of the above-indicated alcohols (used to synthesize the polyester polyols) with dialkyl carbonates, diaryl carbonates, or phosgene.
Polyacrylate and polymethacrylate polyols.
Polyhydroxy-terminated polybutadiene polyols such as, for example, those that can be synthesized by polymerization of 1,3-butadiene and allyl alcohol.
Polyhydroxy-terminated acrylonitrile/polybutadiene copolymers, such as can be synthesized, for example, from epoxides or amino alcohols and carboxyl-terminated acrylonitrile/polybutadiene copolymers (commercially available under the name Hycar® CTBN from Hanse Chemie).

The indicated polyols have an average molecular weight from 250 to 30 000 g/mol, in particular from 1000 to 30 000 g/mol, and an average number of —OH functional groups in the range from 1.6 to 3.

In addition to the indicated polyols, the following can be used to make the polyurethane polymer of embodiments: low molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, and undecanediols, 1,3- and 1,4-cyclohexanedimethanol, hydrogenated bisphenol A, dimers of fatty alcohols, 1,1,1-trimethylolethane, 1,1,1-trimethylolpropane, glycerol, pentaerythritol, sugar alcohols and other alcohols with a high number of —OH groups, low molecular weight alkoxylation products of the aforementioned dihydric and polyhydric alcohols as well as mixtures of the aforementioned alcohols.

For example, the following commercially available polyisocyanates can be used as the polyisocyanates to make the isocyanate-functional polyurethane polymer P1: 2,4- and 2,6-toluoylene diisocyanate (TDI) and any mixture of their isomers, 4,4′-, 2,4′, and 2,2′-diphenylmethane diisocyanate (MDI) and any mixtures of those and other isomers, 1,3- and 1,4-phenylene diisocyanate, 2,3,5,6-tetramethyl-1,4-diisocyanatobenzene, 1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,12-dodecamethylene diisocyanate, cyclohexane-1,3- and -1,4-diisocyanate and any mixtures of those isomers, 1-isocyanato-3,3,5-trimethyl-5-isocyanatomethyl cyclohexane (sophorone diisocyanate or IPDI), perhydro-2,4′- and -4,4′-diphenylmethane diisocyanate (HMDI), 1,4-diisocyanato-2,2,6-trimethyl cyclohexane (TMCDI), m- and p-xylene diisocyanate (XDI), 1,3- and 1,4-tetramethylxylylene diisocyanate (TMXDI), 1,3- and 1,4-bis(isocyanatomethyl)cyclohexane, oligomers and polymers of the aforementioned isocyanates, as well as any mixtures of the aforementioned isocyanates. MDI, TDI, HDI, and IPDI are preferred.

In another embodiment, the polymer P may be a polyurethane polymer P2 having both silane and isocyanate groups, which for example can be obtained by reaction of an isocyanate-functional polyurethane polymer with a silane having an NCO-reactive group, where the silane is used in a substoichiometric amount relative to the isocyanate groups of the polyurethane polymer.

In another embodiment, the polymer P may be a silane-functional polyurethane polymer P3, which can be obtained by reaction of an isocyanate-functional polyurethane polymer with a silane having an NCO-reactive group, where the silane is used in a stoichiometric amount or in a slight stoichiometric excess relative to the isocyanate groups of the polyurethane polymer.

Silanes of formula (V) may be used, in embodiments, as the silanes having an NCO-reactive group used to make polymers P2 and P3, where aminosilanes may be used in particular embodiments. Aminosilanes of formula (VII) may be used in some embodiments. The same aminosilanes that have been indicated as suitable or especially suitable for synthesis of a silane of formula (II) containing a urea or thiourea group are also suitable or especially suitable for synthesis of polymers P2 and P3. N-(3-Trimethoxysilyl)propyl aminosuccinic acid diethyl ester should be specifically mentioned.

Isocyanate-functional polyurethane polymers that may be suitable for synthesis of polymers P2 and P3 include the already described isocyanate-functional polyurethane polymers P1, which can be obtained by reaction of at least one polyisocyanate with at least one polyol, where the polyisocyanate is measured out so that its isocyanate groups are present in stoichiometric excess relative to the hydroxyl groups of the polyol. The free isocyanate group content in the polyurethane polymer is typically 0.1 to 5 wt. %, such as 0.25 to 2.5 wt. %, or 0.3 to 1 wt. %, relative to the total weight of the polymer in the composition. The polyurethane polymer can optionally be made together with the use of plasticizers, where the plasticizers used do not contain any groups that react with isocyanates.

In some embodiments, the isocyanate-functional polyurethane polymers may be isocyanate-functional polyurethane polymers that have the indicated free isocyanate group content, which can be obtained by reaction of diisocyanates with high molecular weight diols with an NCO/OH ratio of 1.5/1 to 2/1.

Polyoxyalkylene diols, in particular polyoxypropylene diols, may be used, in some exemplary embodiments, as the polyols for synthesis of the latter isocyanate-functional polyurethane polymers. High molecular weight polyoxypropylene diols with a degree of unsaturation below 0.02 meq/g and a molecular weight in the range from 4000 to 30 000 g/mol are especially suitable, in particular those with a molecular weight in the range from 8000 to 20 000 g/mol.

A moisture-curing composition containing at least one silane (I) and at least one silane-functional polyurethane polymer P3 may also be synthesized in a one-step process, i.e., the silane (1) and the silane-functional polyurethane polymer P3 are not separately synthesized and then mixed together, but rather are synthesized together in one step. Also an isocyanate-functional polyurethane polymer and a monoisocyanate or monoisothiocyanate of formula (VI) can be mixed, and the mixture can be reacted stoichiometrically with a silane of formula (V).

In another embodiment, the polymer P may be a silane-functional polymer P4, which can be obtained by reaction of a hydroxyl group-containing polymer with an isocyanate-functional silane. This reaction is carried out with the isocyanate groups and hydroxyl groups in stoichiometric proportions, for example at temperatures of 20° C. to 100° C., optionally using catalysts.

Compounds of formula (VIII) are suitable, for use in exemplary embodiments, as the isocyanate-functional silanes:

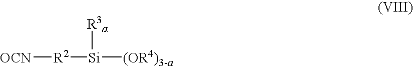

in which R², R³, R⁴ and a have the same meaning as in formula (I).

Examples of suitable isocyanatosilanes include 3-isocyanatopropyl trimethoxysilane, 3-isocyanatopropyl dimethoxymethylsilane, isocyanatomethyl trimethoxysilane, isocyanatomethyl dimethoxymethylsilane, as well as their analogs with ethoxy groups instead of methoxy groups on the silicon.

On the one hand, the already-indicated high molecular-weight polyoxyalkylene polyols may be suitable for use in embodiments as the hydroxyl group-containing polymers; in particular embodiments, polyoxypropylene diols with a degree of unsaturation below 0.02 meq/g and a molecular weight in the range from 4000 to 30 000 g/mol, such as those with a molecular weight in the range from 8000 to 20 000 g/mol, may be used.

On the other hand, hydroxyl group-containing polyurethane polymers are also suitable for reaction with isocyanatosilanes of formula (VIII) in some embodiments. Such hydroxyl group-containing polyurethane polymers can be obtained by reaction of at least one polyisocyanate with at least one polyol. This reaction can be carried out in such a way that the polyol and the polyisocyanate are reacted by a conventional procedure such as, for example, at temperatures from 50° C. to 100° C., optionally using suitable catalysts, where the polyol is measured out so that its hydroxyl groups are present in stoichiometric excess relative to the isocyanate groups of the polyisocyanate. The ratio of hydroxyl groups to isocyanate groups may be from 1.3/1 to 4/1, such as from 1.8/1 to 2.1/1. The polyurethane polymer can optionally be made together with the use of plasticizers, where the plasticizers used do not contain any groups that react with isocyanates. The same polyols and polyisocyanates are suitable for this reaction that have already been mentioned as suitable for synthesis of an isocyanate-functional polyurethane polymer P1.

In another embodiment, the polymer P may be a silane-functional polymer P5, which can be obtained by hydrosilylation of a polymer with terminal double bonds. For example, suitable silane-functional polyisobutylene polymers are obtained by hydrosilylation of polyisobutylene polymers with terminal double bonds. Silane-functional poly(meth)acrylate polymers or polyether polymers are especially suitable for use in embodiments, as are obtained by hydrosilylation of poly(meth)acrylate polymers or polyether polymers with terminal double bonds, in particular allyl-terminated polyoxyalkylene polymers as described, for example, in U.S. Pat. No. 3,971,751 and U.S. Pat. No. 6,207,766.

In a particular embodiment, the polymer may be one or more silane-functional polymer P3, P4 or P5.

The moisture-curing composition of exemplary embodiments may contain other components, in addition to silane-functional and/or isocyanate-functional polymer P and silane (I), which, however, do not reduce the stability in storage of the composition, i.e., during storage, the reaction of the silane groups contained in the composition leading to crosslinking must not be initiated to a significant extent. This means, in particular, that such additional components should not contain or liberate any water, or at most should contain or liberate traces of water. The following well-known aids and additives can be present as additional components, inter alia:

Plasticizers, for example esters of organic carboxylic acids or their anhydrides, phthalates such as, for example, dioctylphthalate or diisodecylphthalate, adipates such as, for example, dioctyladipate, sebacates, polyols such as, for example, polyoxyalkylene polyols or polyester polyols, organic phosphoric and sulfonic acid esters or polybutenes; solvents; inorganic and organic fillers such as, for example, ground or precipitated calcium carbonates, which optionally are coated with stearates, in particular finely divided coated calcium carbonate, carbon blacks, kaolins, aluminum oxides, silicic acids, PVC powder or hollow spheres; fibers, for example polyethylene fibers; pigments; catalysts such as, for example, organotin compounds such as dibutyltin dilaurate, dibutyltin diacetylacetonate, organobismuth compounds or bismuth complexes, or amino group-containing compounds such as, for example, 1,4-diazabicyclo[2.2.2]octane, 2,2′-dimorpholinodiethyl ether, or aminosilanes; rheology modifiers such as, for example, thickeners, for example urea compounds, polyamide waxes, bentonites or pyrogenic silicic acids; adhesion promoters such as, for example, aminosilanes or epoxysilanes, in particular 3-aminopropyl trimethoxysilane, 3-aminopropyl triethoxysilane, N-(2-aminoethyl)-3-aminopropyl trimethoxysilane, or bis(3-(trimethoxysilyl)propyl)amine, as well as oligomeric forms of these silanes; crosslinkers such as, for example, silane-functional oligomers and polymers; drying agents such as, for example, vinyl trimethoxysilane or other rapidly hydrolyzing silanes such as, for example, organoalkoxysilanes which in the α-position relative to the silane group have a functional group such as, for example, aminomethyl trimethoxysilane, N-phenyl aminomethyl trimethoxysilane, N-cyclohexyl aminomethyl trimethoxysilane, methacryloxymethyl trimethoxysilane, N-(trimethoxysilylmethyl)-O-methylcarbamate and N-(dimethoxymethylsilylmethyl)-O-methylcarbamate, orthoformic acid esters, calcium oxide or molecular sieves; heat, light, and UV radiation stabilizers; flame retardants; surfactants such as, for example, wetting agents, flow-control agents, degassers or defoamers; algicides; fungicides or mold growth inhibitors; as well as other conventionally used substances.

The moisture-curing composition of embodiments is stored away from moisture. It is stable in storage, i.e., it can be stored away from moisture in suitable packaging or devices, such as for example in a drum, a bag, or a cartridge, for a period of several months up to a year or longer, without alteration of its application properties or properties after curing to an extent relevant for its use.

During application of the moisture-curing composition of embodiments, the surface of any, at least one solid or article is in partial or complete contact with the composition. Uniform contact is preferred in some embodiments. Before contact, physical and/or chemical pretreatment of the solid or the article that will be brought into contact may be quite necessary, for example by grinding, sand blasting, brushing, or the like, or by treatment with cleaning agents, solvents, adhesion promoters, adhesion promoter solutions or primers, or by applying a bond coat or a sealer.

During application of the moisture-curing composition of embodiments to at least one solid or article, the silane and/or isocyanate groups of polymer P and the silane groups of silane (I) come in contact with moisture. Isocyanate groups react with moisture with elimination of carbon dioxide to form amino groups, which rapidly react further with additional isocyanate groups to form urea groups. The silane groups have the property that they undergo hydrolysis when in contact with moisture. Organosilanols are thus formed (organosilicon compounds containing one or more silanol groups, Si—OH groups) and, by means of subsequent condensation reactions, organosiloxanes are formed (organosilicon compounds containing one or more siloxane groups, Si—O—Si groups). By means of such reactions, the composition ultimately cures to form an elastic material; this process is also called crosslinking. The water needed for the curing reaction can either come from the air (air humidity) or else the composition can be brought into contact with a water-containing component, for example by coating, for example with a tooling agent, or by spraying, or a water-containing component can be added to the composition during application, for example in the form of a water-containing paste that is mixed into it, for example, using a static mixer. Curing of the composition occurs rapidly and completely, regardless of whether the water required comes from the air or is added. The type of curing that is especially important in practice, using air humidity, is completed within a few days under suitable climatic conditions, for example at 23° C. and 50% relative air humidity.

For example, an exemplary moisture-curing composition can be used as an adhesive, sealant, or coating. Suitable applications, for example, are bonding components used in civil engineering and in manufacture or repair of industrial goods or consumer goods, in particular means of transport such as water or land vehicles, such as automobiles, buses, freight vehicles, trains, or ships; sealing joints, seams, or cavities in industrial manufacture or repair, or in civil engineering; as well as coating various substrates, for example as paint, lacquer, primer, seal or protective coating, or as floor covering, for example for offices, living areas, health care facilities, schools, warehouses, and parking garages.

In particular embodiments, the moisture-curing compositions, which contain at least one silane-functional polymer P, have very good mechanical properties in the cured state. These properties are clearly better than for a similar composition not containing any silane (I). Better mechanical properties mean increased stretchability without loss of tear strength. Often even an increase in tear strength is observed. In many applications, in particular use as an elastic adhesive, elastic sealant, or elastic coating, the observed change in mechanical properties means an improvement in product quality.

While the disclosure is not limited to any theory, it is believed that two structural features of silane (I) in particular are responsible for the observed improvement in the mechanical properties of the cured composition. First, silane (I) does not contain any other reactive groups, besides the silane groups, which could react with the silane-functional polymer P during storage and/or during curing. Second, it contains a urea or thiourea or carbamate or thiocarbamate group. Presumably these structural features contribute to the fact that, possibly because of favorable kinetics for the hydrolysis and/or condensation reaction, and/or a special chemical affinity for silane-functional polymer P, during curing of the silane-functional polymer P the silane (I) is very effectively bound in the crosslinks of the curing polymer. Then compared with a cured polymer from an analogous composition not containing any silane (I), it has lower crosslink density, which is expressed in reduced brittleness and thus increased stretchability and good tear strength.

In principle, various methods can be used when employing the moisture-curing composition of embodiments as an adhesive, sealant, or coating.

For example, embodiments disclosed herein may include a method for bonding two substrates S1 and S2 by means of the composition, where substrates S1 and S2 can be made from different or identical materials. After application of the composition, it cures by means of contact with moisture. After curing, the result is a bonded article. Such an article can be a structure, in particular a civil engineering structure, or a means of transport. The article of exemplary embodiments is a means of transport, in particular a water or land vehicle, such as an automobile, a bus, a freight vehicle, a train, or a ship, or a portion thereof. For example, these can be components or modules of means of transport. However, the article can also be a structure or part of a structure.

Furthermore, it may be a sealing method which includes the following steps: Application of the composition between two substrates S1 and S2, where substrates S1 and S2 are made from different or identical materials, and curing the composition by contact with moisture. After curing, the result may be a sealed article. Such an article may in particular be a means of transport or a structure. In particular, the composition may be a sealing joint for such sealed articles.

Suitable substrates S1 or S2 may be, for example, inorganic substrates such as, for example, glass, glass ceramic, concrete, mortar, brick, tile, plaster, and natural stones such as granite or marble; metals or alloys such as aluminum, steel, nonferrous metals, galvanized metals; organic substrates such as wood, plastics such as PVC, polycarbonates, PMMA, polyesters, epoxy resins; coated substrates such as, for example, powder-coated metals or alloys; as well as paints and lacquers, in particular automotive topcoats.

### EXAMPLES

### Description of Test Methods

The tensile strength, the elongation at break, and the modulus of elasticity for 0%-20% elongation were determined on films cured for 7 days at 23° C. and 50% relative air humidity, with a layer thickness of 2 mm, according to DIN EN 53504 (pull rate: 200 mm/min).

The tear strength was measured on films cured for 7 days at 23° C. and 50% relative air humidity, with a layer thickness of 2 mm, according to DIN ISO 34-1 (test rate: 500 mm/min).

The Shore A hardness was determined according to DIN 53505.

The viscosity was measured on a thermostatted Haake VT-500 cone-and-plate viscometer (cone diameter 20 mm, cone angle 1°, gap between cone tip and plate 0.05 mm, shear rate 10 to 100 s⁻¹).

Abbreviations Used in the Tables

Ref. Reference

inv. according to the invention

comp. Comparison

% wt. %

a) Preparation of Silanes

N-(3-Trimethoxysilyl)propyl aminosuccinic acid diethyl ester

17.2 g (100 mmol) maleic acid diethyl ester was slowly added dropwise with good stirring and exclusion of moisture to 17.9 g (100 mmol) of 3-aminopropyl trimethoxysilane (Silquest® A-1110, GE Advanced Materials), and then stirring was continued for another 2 hours. A colorless liquid was obtained, with viscosity at 20° C. of 60 mPa·s.

N-(3-Triethoxysilyl)propyl aminosuccinic acid diethyl ester

17.2 g (100 mmol) maleic acid diethyl ester was slowly added dropwise with good stirring and exclusion of moisture to 22.1 g (100 mmol) of 3-aminopropyl triethoxysilane (Silquest® A-100, GE Advanced Materials), and then stirring was continued for another 2 hours. A colorless liquid was obtained, with viscosity at 20° C. of 130 mPa·s.

N-(3-Dimethoxymethylsilyl)propyl aminosuccinic acid diethyl ester

17.2 g® 100 mmol) maleic acid diethyl ester was slowly added dropwise with good stirring and exclusion of moisture to 16.3 g (100 mmol) of 3-aminopropyl dimethoxmethylsilane (Silquest® A-2110C, OSi-Crompton), and then stirring was continued for another 2 hours. A colorless liquid was obtained, with viscosity at 20° C. of 100 mPa·s.

N-(4-Dimethoxymethylsilyl-2,2-dimethyl)butyl aminosuccinic acid diethyl ester

17.2 g (100 mmol) maleic acid diethyl ester was slowly added dropwise with good stirring and exclusion of moisture to 20.5 g (100 mmol) of 4-amino-3,3-dimethylbutyl dimethoxymethylsilane (Silquest® A-2639, GE Advanced Materials), and then stirring was continued for another 2 hours. A colorless liquid was obtained, with viscosity at 20° C. of 210 mPa·s.

N-(3-Trimethoxysilyl)propyl-3-aminopropionic acid tetrahydrofuryl ester

15.6 g (100 mmol) tetrahydrofuryl acrylate was slowly added dropwise with good stirring and exclusion of moisture to 17.9 g (100 mmol) of 3-aminopropyl trimethoxysilane (Silquest® A-1110, GE Advanced Materials), and then stirring was continued for another 2 hours at 60° C. A colorless liquid was obtained, with viscosity at 20° C. of 270 mPa·s.

N-(3-Trimethoxysilyl)propyl-3-aminopropionitrile

5.3 g (100 mmol) acrylonitrile was slowly added dropwise with good stirring and exclusion of moisture to 17.9 g (100 mmol) of 3-aminopropyl trimethoxysilane (Silquest® A-1110, GE Advanced Materials), and then stirring was continued for another 2 hours at 60° C. A colorless liquid was obtained, with viscosity at 20° C. of 220 mPa·s.

N-(3-Trimethoxysilyl)propyl-2-aminoethylphosphonic acid dimethyl ester

13.6 g (100 mmol) of freshly distilled vinylphosphonic acid dimethyl ester (boiling point about 100° C. at 10 mbar) was slowly added dropwise with good stirring and exclusion of moisture to 17.9 g (100 mmol) of 3-aminopropyl trimethoxysilane (Silquest® A-1110, GE Advanced Materials), and then stirring was continued for another 2 hours at 60° C. A colorless liquid was obtained, with viscosity at 20° C. of 300 mPa·s.

### Example 1

### Sil-1

35.1 g (100 mmol) of N-(3-trimethoxysilyl)propyl aminosuccinic acid diethyl ester was added dropwise at 20° C.-30° C. with good stirring and exclusion of moisture to 11.9 g (100 mmol) phenyl isocyanate, and the mixture was stirred until the NCO band at 2270 cm⁻¹ in the FT-IR spectrum disappeared. A colorless liquid was obtained, with viscosity at 20° C. of 3000 mPa·s.

### Example 2

### Sil-2

35.1 g (100 mmol) of N-(3-trimethoxysilyl)propyl aminosuccinic acid diethyl ester was added dropwise at 20° C.-30° C. with good stirring and exclusion of moisture to 13.5 g (100 mmol) phenyl isothiocyanate, and the mixture was stirred until the NCS band at 2087 cm⁻¹ in the FT-IR spectrum disappeared. A colorless liquid was obtained, with viscosity at 20° C. of 600 mPa·s.

### Example 3

### Sil-3

35.1 g (100 mmol) of N-(3-trimethoxysilyl)propyl aminosuccinic acid diethyl ester was added dropwise at 20° C.-30° C. with good stirring and exclusion of moisture to 12.5 g (100 mmol) cyclohexyl isocyanate, and the mixture was stirred until the NCO band at 2270 cm⁻¹ in the FT-IR spectrum disappeared. A colorless liquid was obtained, with viscosity at 20° C. of 2300 mPa·s.

### Example 4

### Sil-4

35.1 g (100 mmol) of (3-trimethoxysilyl)propyl aminosuccinic acid diethyl ester was added dropwise at 20° C.-30° C. with good stirring and exclusion of moisture to 9.9 g (100 mmol) n-butyl isocyanate, and the mixture was stirred until the NCO band at 2270 cm⁻¹ in the FT-IR spectrum disappeared. A colorless liquid was obtained, with viscosity at 20° C. of 600 mPa·s.

### Example 5

### Sil-5

39.4 g (100 mmol) of N-(3-triethoxysilyl)propyl aminosuccinic acid diethyl ester was added dropwise at 20° C.-30° C. with good stirring and exclusion of moisture to 11.9 g (100 mmol) phenyl isocyanate, and the mixture was stirred until the NCO band at 2270 cm⁻¹ in the FT-IR spectrum disappeared. A colorless liquid was obtained, with viscosity at 20° C. of 600 mPa·s.

### Example 6

### Sil-6

33.5 g (100 mmol) of N-(3-dimethoxymethylsilyl)propyl aminosuccinic acid diethyl ester was added dropwise at 20° C.-30° C. with good stirring and exclusion of moisture to 11.9 g (100 mmol) phenyl isocyanate, and the mixture was stirred until the NCO band at 2270 cm⁻¹ in the FT-IR spectrum disappeared. A colorless liquid was obtained, with viscosity at 20° C. of 3500 mPa·s.

### Example 7

### Sil-7

37.8 g (100 mmol) of N-(4-dimethoxymethylsilyl-2,2-dimethyl-butyl)aminosuccinic acid diethyl ester was added dropwise at 20° C.-30° C. with good stirring and exclusion of moisture to 11.9 g (100 mmol) phenyl isocyanate, and the mixture was stirred until the NCO band at 2270 cm⁻¹ in the FT-IR spectrum disappeared. The liquid obtained gradually crystallized to form colorless crystals with melting point 90° C.-95° C.

### Example 8

### Sil-8

33.5 g (100 mmol) of N-(3-dimethoxymethylsilyl)propyl aminosuccinic acid diethyl ester was added dropwise at 20° C.-30° C. with good stirring and exclusion of moisture to 9.9 g (100 mmol) butyl isocyanate, and the mixture was stirred until the NCO band at 2270 cm⁻¹ in the FT-IR spectrum disappeared. A colorless liquid was obtained, with viscosity at 20° C. of 300 mPa·s.

### Example 9

### Sil-9

25.5 g (100 mmol) of N-phenyl-3-aminopropyl trimethoxysilane (Silquest® Y-9669, GE Advanced Materials) was added dropwise at 20° C.-30° C. with good stirring and exclusion of moisture to 11.9 g (100 mmol) phenyl isocyanate, the mixture was slowly heated to 70° C. and stirred until the NCO band at 2270 cm⁻¹ in the FT-IR spectrum disappeared. A colorless liquid was obtained, with viscosity at 20° C. of 2100 mPa·s.

### Example 10

### Sil-10

26.1 g (100 mmol) of N-cyclohexyl-3-aminopropyl trimethoxysilane (Geniosil® GF92, Wacker) was added dropwise at 20° C.-30° C. with good stirring and exclusion of moisture to 11.9 g (100 mmol) phenyl isocyanate, and the mixture was stirred until the NCO band at 2270 cm⁻¹ in the FT-IR spectrum disappeared. A colorless liquid was obtained, with viscosity at 20° C. of about 250 mPa·s.

### Example 11

### Sil-11

22.7 g (100 mmol) of N-phenyl aminomethyl trimethoxysilane (Geniosil® XL 973, Wacker) was added dropwise at 20° C.-30° C. with good stirring and exclusion of moisture to 11.9 g (100 mmol) phenyl isocyanate, the mixture was slowly heated to 70° C. and stirred until the NCO band at 2270 cm⁻¹ in the FT-IR spectrum disappeared. A colorless liquid was obtained, with viscosity at 20° C. of about 400 mPa·s.

### Example 12

### Sil-12

21.1 g (100 mmol) of N-phenyl aminomethyl dimethoxymethylsilane (Geniosil® XL 972, Wacker) was added dropwise at 20° C.-30° C. with good stirring and exclusion of moisture to 11.9 g (100 mmol) phenyl isocyanate, the mixture was slowly heated to 70° C. and stirred until the NCO band at 2270 cm⁻¹ in the FT-IR spectrum disappeared. A colorless liquid was obtained, with viscosity at 20° C. of about 600 mPa·s.

### Example 13

### Sil-13

27.5 g (100 mmol) of N-cyclohexyl aminomethyl triethoxysilane (Geniosil® XL 926, Wacker) was added dropwise at 20° C.-30° C. with good stirring and exclusion of moisture to 11.9 g (100 mmol) phenyl isocyanate, and the mixture was stirred until the NCO band at 2270 cm⁻¹ in the FT-IR spectrum disappeared. A colorless liquid was obtained, with viscosity at 20° C. of about 1100 mPa·s.

### Example 14

### Sil-14

24.5 g (100 mmol) of N-cyclohexyl aminomethyl diethoxymethylsilane (Geniosil® XL 924, Wacker) was added dropwise at 20° C.-30° C. with good stirring and exclusion of moisture to 11.9 g (100 mmol) phenyl isocyanate, and the mixture was stirred until the NCO band at 2270 cm⁻¹ in the FT-IR spectrum disappeared. A colorless liquid was obtained, with viscosity at 20° C. of 1000 mPa·s.

### Example 15

### Sil-15

33.5 g (100 mmol) of N-(3-trimethoxysilyl)propyl-3-aminopropionic acid tetrahydrofuryl ester was added dropwise at 20° C.-30° C. with good stirring and exclusion of moisture to 9.9 g (100 mmol) butyl isocyanate, and the mixture was stirred until the NCO band at 2270 cm⁻¹ in the FT-IR spectrum disappeared. A colorless liquid was obtained, with viscosity at 20° C. of 480 mPa·s.

### Example 16

### Sil-16

23.2 g (100 mmol) of N-(3-trimethoxysilyl)propyl-3-aminopropionitrile was added dropwise at 20° C.-30° C. with good stirring and exclusion of moisture to 9.9 g (100 mmol) butyl isocyanate, and the mixture was stirred until the NCO band at 2270 cm⁻¹ in the FT-IR spectrum disappeared. A colorless liquid was obtained, with viscosity at 20° C. of 600 mPa·s.

### Example 17

### Sil-17

31.5 g (100 mmol) of N-(3-trimethoxysilyl)propyl-2-aminoethylphosphonic acid dimethyl ester was added dropwise at 20° C.-30° C. with good stirring and exclusion of moisture to 9.9 g (100 mmol) butyl isocyanate, and the mixture was stirred until the NCO band at 2270 cm⁻¹ in the FT-IR spectrum disappeared. A colorless liquid was obtained, with viscosity at 20° C. of 1200 mPa·s.

### Example 18 (Comparison)

### Sil-18

24.5 g (100 mmol) of an adduct of maleic acid diethyl ester and butylamine was added dropwise at about 20° C.-30° C. with good stirring and exclusion of moisture to 20.5 g (100 mmol) of 3-isocyanatopropyl trimethoxysilane (Geniosil® GF 40, Wacker), and the mixture was stirred until the NCO band at 2270 cm⁻¹ in the FT-IR spectrum disappeared. A colorless liquid was obtained, with viscosity at 20° C. of 1000 mPa·s.

The adduct of maleic acid diethyl ester and butylamine was prepared by adding 17.2 g (100 mmol) of maleic acid diethyl ester dropwise at about 20° C.-30° C. with good stirring and exclusion of moisture to 7.3 g (100 mmol) butylamine, and then stirring was continued for 2 hours. A colorless liquid was obtained, with viscosity at 20° C. of 25 mPa·s.

### Example 19 (Comparison)

### Sil-19

17.9 g (100 mmol) of 3-aminopropyl trimethoxysilane (Silquest® A-1110, GE Advanced Materials) was added dropwise at 20° C.-30° C. with good stirring and exclusion of moisture to 9.9 g (100 mmol) butyl isocyanate, and the mixture was stirred until the NCO band at 2270 cm⁻¹ in the FT-IR spectrum disappeared. A colorless liquid was obtained, with viscosity at 20° C. of 300 mPa·s.

TABLE 1
Formulas of prepared silanes Sil-1 to Sil-19.

| | |
|---|---|
| | Sil-1 |
| 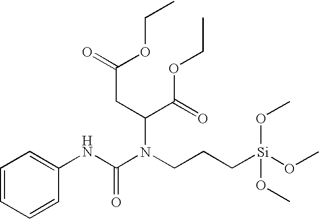 | |
| | Sil-2 |
| 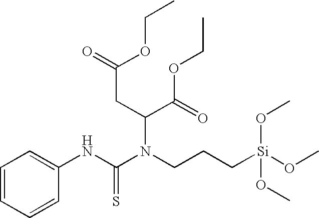 | |
| | Sil-3 |
| 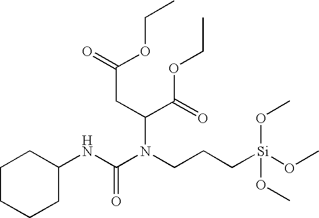 | |
| | Sil-4 |
| 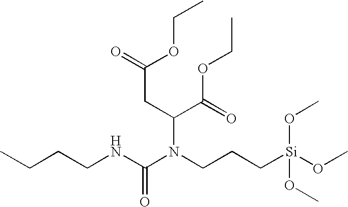 | |
| | Sil-5 |
| 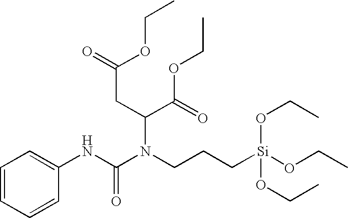 | |
| | Sil-6 |
| 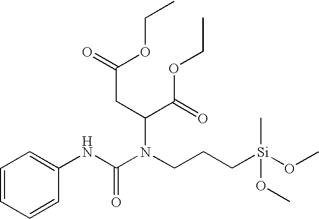 | |
| | Sil-7 |
| 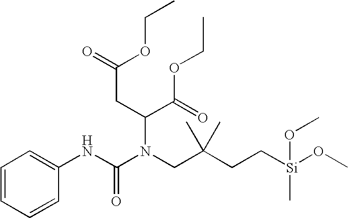 | |
| | Sil-8 |
| 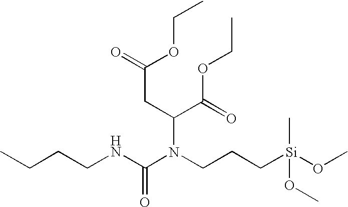 | |
| | Sil-9 |
| 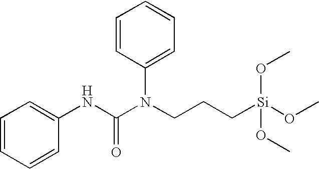 | |

| | |
|---|---|
| | Sil-10 |
| 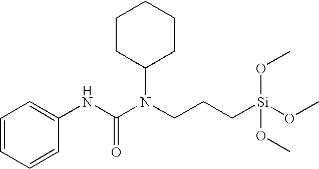 | |
| | Sil-11 |
| 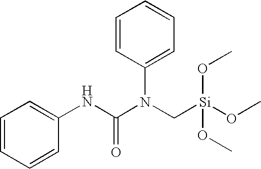 | |
| | Sil-12 |
| 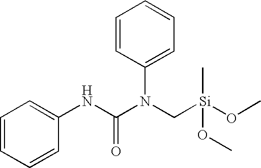 | |
| | Sil-13 |
| 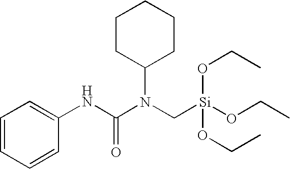 | |
| | Sil-14 |
| 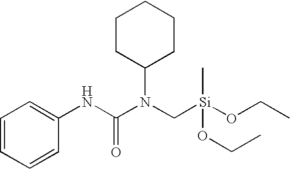 | |
| | Sil-15 |
| 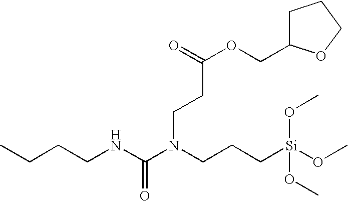 | |
| | Sil-16 |
| 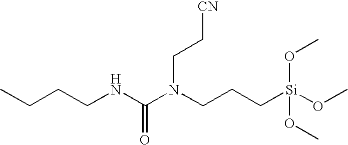 | |
| | Sil-17 |
| 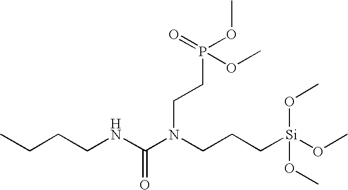 | |
| | Sil-18 |
| 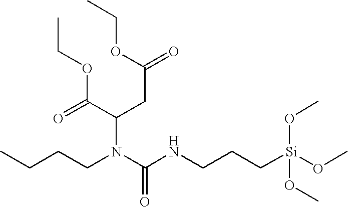 | |
| | Sil-19 |
| 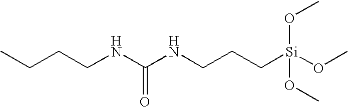 | |

b) Preparation of Silane-Functional Polymers

Polymer SP-1

1000 g of the polyol Acclaim® 12200 (Bayer; low monol polyoxypropylene diol, OH-value 11.0 mg KOH/g, water content about 0.02 wt. %), 43.6 g isophorone diisocyanate (IPDI; Vestanat® IPDI, Degussa), 126.4 g diisodecylphthalate (DIDP; Palatinol® Z, BASF), and 0.12 g di-n-butyltin dilaurate were heated to 90° C. with exclusion of moisture and continuous stirring, and kept at this temperature until the titrimetrically determined free isocyanate group content reached a value of 0.63 wt. %. Then 62.3 g of N-(3-trimethoxysilyl)propyl aminosuccinic acid diethyl ester was mixed in, and the mixture was stirred at 90° C. until free isocyanate could no longer be detected by FT-IR spectroscopy. The silane-functional polyurethane polymer was cooled down to room temperature and stored away from moisture.

Polymer SP-2

1000 g of the polyol Acclaim® 12200 (Bayer; low monol polyoxypropylene diol, OH value 11.0 mg KOH/g, water content about 0.02 wt. %) and 34.3 g of 2,4-toluoylene diisocyanate were reacted at 80° C. with exclusion of moisture, according to a known procedure, to form a polyurethane polymer with a titrimetrically determined isocyanate group content of 0.8 wt. %. Then 69.2 g N-(3-trimethoxysilyl)propyl aminosuccinic acid diethyl ester was mixed in at 80° C., and the mixture was stirred at 80° C. until free isocyanate could no longer be detected by FT-IR spectroscopy. The silane-functional polyurethane polymer was cooled down to room temperature and stored away from moisture.

Polymer SP-3

1000 g of the polyol Acclaim® 12200 (Bayer; low monol polyoxypropylene diol, OH value 11.0 mg KOH/g, water content about 0.02 wt. %) and 34.3 g of 2,4-toluoylene diisocyanate were reacted at 80° C. with exclusion of moisture, according to a known procedure, to form a polyurethane polymer with a titrimetrically determined isocyanate group content of 0.8 wt. %. Then 77.5 g of N-(3-triethoxysilyl)propyl aminosuccinic acid diethyl ester was mixed in at 80° C., and the mixture was stirred at 80° C. until free isocyanate could no longer be detected by FT-IR spectroscopy. The silane-functional polyurethane polymer was cooled down to room temperature and stored away from moisture.

Polymer SP-4

1000 g of the polyol Acclaim® 12200 (Bayer; low monol polyoxypropylene diol, OH value 11.0 mg KOH/g, water content about 0.02 wt. %) and 34.3 g of 2,4-toluoylene diisocyanate were reacted at 80° C. with exclusion of moisture, according to a known procedure, to form a polyurethane polymer with a titrimetrically determined isocyanate group content of 0.8 wt. %. Then 66.0 g of N-(3-Dimethoxymethylsilyl)propyl aminosuccinic acid diethyl ester was mixed in at 80° C., and the mixture was stirred at 80° C. until free isocyanate could no longer be detected by FT-IR spectroscopy. The silane-functional polyurethane polymer was cooled down to room temperature and stored away from moisture.

Polymer SP-5

1000 g of the polyol Acclaim® 12200 (Bayer; low monol polyoxypropylene diol, OH value 11.0 mg KOH/g, water content about 0.02 wt. %) and 34.3 g of 2,4-toluoylene diisocyanate were reacted at 80° C. with exclusion of moisture, according to a known procedure, to form a polyurethane polymer with a titrimetrically determined isocyanate group content of 0.8 wt. %. Then 46.3 g of N-(n-butyl)-3-aminopropyl trimethoxysilane (Dynasylan® 1189, Degussa) was mixed in at 80° C., and the mixture was stirred at 80° C. until free isocyanate could no longer be detected by FT-IR spectroscopy. The silane-functional polyurethane polymer was cooled down to room temperature and stored away from moisture.

Polymer SP-6

1000 g of the polyol Acclaim® 12200 (Bayer; low monol polyoxypropylene diol, OH value 11.0 mg KOH/g, water content about 0.02 wt. %) and 40.4 g of 3-isocyanatopropyl trimethoxysilane (Geniosil® GF 40, Wacker) were reacted at 90° C. with exclusion of moisture, according to a known procedure, until free isocyanate could no longer be detected by FT-IR spectroscopy. The silane-functional polyurethane polymer was cooled down to room temperature and stored away from moisture.

Polymer SP-7

Silane-functional polyether polymer (MS-Polymer S203H from Kaneka).

c) Preparation of Compositions

The amounts of silane-functional polymer, tin catalyst, amine catalyst, and silane given in the respective tables were uniformly mixed under vacuum and added to an aluminum tube with exclusion of moisture. Then a cured film of layer thickness 2 mm was prepared with each composition (Z).

### Examples Z1 to Z5

Silane Sil-1 was added in different concentrations to silane-functional polymer SP-2 (Z2 to Z5) and compared with the reference composition Z1, which did not contain any added silane. The amounts and the results are given in Table 2.

TABLE 2
Properties of compositions with polymer SP-2.

| | Z1 | Z2 | Z3 | Z4 | Z5 |
|---|---|---|---|---|---|
| | Ref. | inv. | inv. | inv. | inv. |
| Polymer SP-2 | 98.9% | 94.9% | 91.2% | 84.7% | 79.0% |
| DBTDL^{a} | 0.1% | 0.1% | 0.1% | 0.1% | 0.1% |
| Jeffamine ® D230^{b} | 1.0% | 1.0% | 1.0% | 1.0% | 1.0% |
| Silane Sil-1 | — | 4.0% | 7.7% | 14.2% | 19.9% |
| Tensile strength [MPa] | 0.62 | 0.69 | 0.76 | 1.15 | 1.53 |
| Elongation at break [%] | 83 | 101 | 122 | 222 | 283 |
| Modulus of elasticity | 1.10 | 1.11 | 1.11 | 1.17 | 1.23 |
| [MPa] | | | | | |

^{a}Di-n-butyltin dilaurate.
^{b}α,ω--Polyoxypropylene diamine (Huntsman; amine content = 8.22 mmol NH₂/g)

As the amount of Sil-1 increases, Z2 to Z5 show a clear increase in tensile strength and also especially in elongation at break compared with Z1.

### Examples Z6 to Z20

Table 3 lists the compositions with silane-functional polymer SP-1 and different silanes according to the invention added (Z7 to Z21), which in each case exhibit a clear increase in elongation at break compared with the reference composition Z6 with no added silane.

TABLE 3
Properties of compositions with polymer SP-1.

| | Z6 | Z7 | Z8 | Z9 | Z10 | Z11 | Z12 | Z13 |
|---|---|---|---|---|---|---|---|---|
| | Ref. | inv. | inv. | inv. | inv. | inv. | inv. | inv. |
| SP-1 | 98.0% | 86.1% | 86.3% | 86.9% | 85.5% | 92.0% | 91.5% | 88.6% |
| DBTDL^{a} | 1.0% | 1.0% | 1.0% | 1.0% | 1.0% | 1.0% | 1.0% | 1.0% |
| D230^{b} | 1.0% | 1.0% | 1.0% | 1.0% | 1.0% | 1.0% | 1.0% | 1.0% |
| Silane | — | Sil-2, | Sil-3, | Sil-4, | Sil-5, | Sil-6, | Sil-7, | Sil-9, |
| | | 11.9% | 11.7% | 11.1% | 12.4% | 6.0% | 6.5% | 9.4% |
| TS [MPa]^{c} | 0.44 | 0.80 | 0.42 | 0.41 | 0.54 | 0.39 | 0.45 | 0.45 |
| EB [%]^{d} | 90 | 250 | 220 | 150 | 170 | 150 | 160 | 150 |
| ME [MPa]^{e} | 0.75 | 0.80 | 0.49 | 0.56 | 0.68 | 0.52 | 0.58 | 0.61 |
| | Z6 | Z14 | Z15 | Z16 | Z17 | Z18 | Z19 | Z20 |
| | Ref. | inv. | inv. | inv. | inv. | inv. | inv. | inv. |
| SP-1 | 98.0% | 88.4% | 89.2% | 93.6% | 88.1% | 93.2% | 89.6% | 87.7% |
| DBTDL^{a} | 1.0% | 1.0% | 1.0% | 1.0% | 1.0% | 1.0% | 1.0% | 1.0% |
| D230^{b} | 1.0% | 1.0% | 1.0% | 1.0% | 1.0% | 1.0% | 1.0% | 1.0% |
| Silane | — | Sil-10, | Sil-11, | Sil-12, | Sil-13, | Sil-14, | Sil-16 | Sil-17 |
| | | 9.6% | 8.8% | 4.4% | 9.9% | 4.8% | 8.4% | 10.3% |
| TS [MPa]^{c} | 0.44 | 0.66 | 0.46 | 0.46 | 0.69 | 0.44 | 0.58 | 0.61 |
| EB [%]^{d} | 90 | 220 | 270 | 200 | 220 | 180 | 150 | 190.0% |
| ME [MPa]^{e} | 0.75 | 0.77 | 0.47 | 0.55 | 0.77 | 0.56 | 0.79 | 0.70 |

^{a}Di-n-butyltin dilaurate.
^{b}Jeffamine ® D230: α,ω-polyoxypropylene diamine (Huntsman; amine content = 8.22 mmol NH₂/g).
^{c}Tensile strength.
^{d}Elongation at break.
^{e}Modulus of elasticity.

### Examples Z21 to Z27

### Comparison

Silanes that were not according to the invention were added to silane-functional polymer SP-1, as indicated by the entries in Table 4 (Z21 to Z27). Compared with reference composition Z6, either no increase or an insignificant increase was observed in the elongation at break.

It is interesting that silanes Sil-18 and Sil-19 (neither of which are silanes according to the invention as in formula (I), but they have a similar structure) do not cause any clear increase in stretchability. For example, if we compare the increase in the elongation at break caused by Sil-4 (Example Z9 in Table 3) with the increase in the elongation at break caused by Sil-18 (Example Z26 in Table 4), obviously the silane as in formula (I), and therefore Sil-4, causes a significantly greater increase in the elongation at break than Sil-18.

TABLE 4
Properties of comparison compositions with polymer SP-1.

| | Z6 | Z21 | Z22 | Z23 | Z24 | Z25 | Z26 | Z27 |
|---|---|---|---|---|---|---|---|---|
| | Ref. | comp. | comp. | comp. | comp. | comp. | comp. | comp. |
| SP-1 | 98.0% | 91.4% | 91.2% | 92.8% | 89.1% | 93.2% | 86.9% | 90.8% |
| DBTDL^{a} | 1.0% | 1.0% | 1.0% | 1.0% | 1.0% | 1.0% | 1.0% | 1.0% |
| D230^{b} | 1.0% | 1.0% | 1.0% | 1.0% | 1.0% | 1.0% | 1.0% | 1.0% |
| Silane | — | Y-9669^{f}, | GF-92^{g}, | MTMO^{h}, | BAMOⁱ, | AMMO^{k}, | Sil-18 | Sil-19, |
| | | 6.6% | 6.8% | 5.2% | 8.9% | 4.8% | 11.1% | 7.2% |
| TS [MPa]^{c} | 0.44 | 0.43 | 0.41 | 0.46 | 0.39 | 0.51 | 0.44 | 0.56 |
| EB [%]^{d} | 90 | 110 | 100 | 90 | 100 | 85 | 120 | 95 |
| ME [MPa]^{e} | 0.75 | 0.65 | 0.65 | 0.79 | 0.62 | 0.92 | 0.65 | 0.93 |

^{a}Di-n-butyltin dilaurate.
^{b}Jeffamine ® D230: α,ω-polyoxypropylene diamine (Huntsman; amine content = 8.22 mmol NH₂/g).
^{c}Tensile strength.
^{d}Elongation at break.
^{e}Modulus of elasticity.
^{f}N-Phenyl-3-aminopropyl trimethoxysilane (Silquest ® Y-9669, GE Advanced Materials).
^{g}N-Cyclohexyl-3-aminopropyl trimethoxysilane (Geniosil ® GF92, Wacker).
^{h}3-Mercaptopropyl trimethoxysilane (Silquest ® A-189, GE Advanced Materials).
ⁱ(3-Trimethoxysilyl)propyl aminosuccinic diethyl ester.
^{k}3-Aminopropyl trimethoxysilane (Silquest ® A-1110, GE Advanced Materials).

### Examples Z28 to Z34

Silanes were added to the silane-functional polymers SP-3 and SP-4 as indicated by the entries in Table 5, and they were compared with the respective reference composition with no added silane.

TABLE 5
Properties of compositions with polymer SP-3 and SP-4.

| | Z28 | Z29 | Z30 | Z31 | Z32 | Z33 | Z34 |
|---|---|---|---|---|---|---|---|
| | Ref. | inv. | comp. | comp | Ref. | inv. | inv. |
| Polymer | SP-3, | SP-3, | SP-3, | SP-3, | SP-4, | SP-4, | SP-4, |
| | 98.0% | 83.0% | 90.3% | 89.0% | 98.8% | 91.1% | 91.4% |
| Catalyst | DBTAc^{b} | DBTAc^{b} | DBTAc^{b} | DBTAc^{b} | DBTDL^{c} | DBTDL^{c} | DBTDL^{c} |
| | 1.0% | 1.0% | 1.0% | 1.0% | 0.2% | 0.2% | 0.2% |
| Jeffamine ® D230^{a} | 1.0% | 1.0% | 1.0% | 1.0% | 1.0% | 1.0% | 1.0% |
| Silane | — | Sil-5, | PhTEO^{d} | VTEO^{e}, | — | Sil-1, | Sil-6, |
| | | 15.0% | 7.7% | 9.0% | | 7.7% | 7.4% |
| Tensile strength | 0.55 | 0.88 | 0.57 | 0.65 | 0.69 | 0.94 | 0.86 |
| [MPa] | | | | | | | |
| Elongation at break | 110 | 270 | 120 | 100 | 120 | 180 | 220 |
| [%] | | | | | | | |
| Modulus of elasticity | 0.82 | 1.16 | 1.01 | 1.08 | 1.00 | 1.09 | 0.91 |
| [MPa] | | | | | | | |

^{a}α,ω-polyoxypropylene diamine (Huntsman; amine content = 8.22 mmol NH₂/g).
^{b}Di-n-butyltin diacetylacetonate.
^{c}Di-n-butyltin dilaurate.
^{d}Phenyl triethoxysilane.
^{e}Vinyl triethoxysilane (Geniosil ® GF 56, Wacker).

The compositions according to the invention, Z29 and Z33 and Z34, show a clear increase in elongation at break as well as an increase in tensile strength compared with the respective reference compositions Z28 and Z32. However, the comparison compositions Z30 and Z31, which contain silanes that are not according to the invention, show no increase or only an insignificant increase in elongation at break compared with the reference composition Z28.

### Examples Z35 to Z40

Silanes were added to the silane-functional polymers SP-5, SP-6, and SP-7 as indicated by the entries in Table 6, and they were compared with the respective reference composition with no added silane.

TABLE 6
Properties of compositions with polymer SP-5, SP-6, or SP-7.

| | Z35 | Z36 | Z37 | Z38 | Z39 | Z40 |
|---|---|---|---|---|---|---|
| | Ref. | inv. | Ref. | inv. | Ref. | inv. |
| Polymer | SP-5, | SP-5, | SP-6, | SP-6, | SP-7, | SP-7, |
| | 98.9% | 84.4% | 98.0% | 90.2% | 98.0% | 92.2% |
| Catalyst | DBTDL^{b}, | DBTDL^{b}, | DBTDL^{b}, | DBTDL^{b}, | DBTAC^{c}, | DBTAC^{c}, |
| | 0.1% | 0.1% | 1.0% | 1.0% | 1.0% | 1.0% |
| Jeffamine ® D230^{a} | 1.0% | 1.0% | 1.0% | 1.0% | 1.0% | 1.0% |
| Silane | — | Sil-1, | — | Sil-6, | — | Sil-5, |
| | | 14.5% | | 7.8% | | 5.8% |
| Tensile strength | 0.47 | 0.80 | 0.46 | 0.53 | 0.26 | 0.26 |
| [MPa] | | | | | | |
| Elongation at break | 45 | 130 | 55 | 110 | 190 | 290 |
| [%] | | | | | | |
| Modulus of elasticity | 1.30 | 1.17 | 1.07 | 0.84 | 0.29 | 0.24 |
| [MPa] | | | | | | |

^{a}α,ω-Polyoxypropylene diamine (Huntsman; amine content = 8.22 mmol NH₂/g).
^{b}Di-n-butyltin dilaurate.
^{c}Di-n-butyltin diacetylacetonate.

The results in Table 6 show that both the silane-functional polyurethane polymers SP-5 and SP-6 as well as the silane-functional polyether polymer SP-7, when used together with the silanes according to the invention as indicated in Table 6, exhibit a clear increase in elongation at break.

### Examples Z41 to Z52

A sealant/adhesive base formulation (BF) was prepared by processing the following into a homogeneous paste in a vacuum mixer: 3300 g of silane-functional polymer SP-1, 1335 g diisodecylphthalate (DIDP; Palatinol® Z, BASF), 100 g vinyl trimethoxysilane (Silquest® A-171, GE Advanced Materials), 4400 g of finely divided coated chalk (Socal® U1S2, Solvay; dried), 300 g of pyrogenic silicic acid (Aerosil® 200, Degussa; dried), 100 g of N-(2-aminoethyl)-3-aminopropyl trimethoxysilane (Silquest® A-1120, GE Advanced Materials), and 15 g di-n-butyltin dilaurate, and then the paste was stored away from moisture. The silanes indicated in Table 7 were uniformly mixed into this base formulation BF in a vacuum mixer, and these sealant/adhesive compositions were stored away from moisture.

Reference composition Z41, with no addition of silane (I), is a material with barely satisfactory stretchability, but at the same time with good tensile strength and high tear strength. The compositions Z42 to Z51 according to the invention, which additionally contain a silane (I), compared with Z41 have a clearly to considerably increased elongation at break and also increased tensile strength and sometimes considerably increased tear strength. The observed change in mechanical parameters is very desirable for many sealant and adhesive applications. But the comparison composition Z52, in which a silane not according to the invention was used, compared with reference composition Z41 has lower values for the elongation at break, the tensile strength, and the tear strength.

TABLE 7
Properties of adhesive/sealant compositions.

| | Z41 | Z42 | Z43 | Z44 | Z45 | Z46 | Z47 | Z48 | Z49 | Z50 | Z51 | Z52 |
|---|---|---|---|---|---|---|---|---|---|---|---|---|
| | Ref. | inv. | inv. | inv. | inv. | inv. | inv. | inv. | inv. | inv. | inv. | Comp. |
| Base | 96.0% | 96.0% | 96.0% | 96.0% | 96.0% | 96.0% | 96.0% | 96.0% | 96.0% | 96.0% | 96.0% | 96.0% |
| formulation | | | | | | | | | | | | |
| BF | | | | | | | | | | | | |
| DIDP^{a} | 4.0% | — | — | — | 2.0% | 2.0% | — | 2.0% | — | — | — | — |
| Silane | — | Sil-1, | Sil-4, | Sil-5, | Sil-6, | Sil-8, | Sil-11, | Sil-14, | Sil-15, | Sil-16, | Sil-17, | VTMO^{b}, |
| | | 4.0% | 4.0% | 4.0% | 2.0% | 2.0% | 4.0% | 2.0% | 4.0% | 4.0% | 4.0% | 4.0% |
| Shore A | 49 | 51 | 52 | 51 | 49 | 48 | 37 | 41 | 57 | 57 | 58 | 60 |
| Tensile strength | 2.7 | 3.6 | 4.3 | 3.7 | 3.4 | 3.8 | 4.0 | 4.2 | 3.1 | 3.4 | 3.5 | 2.7 |
| [MPa] | | | | | | | | | | | | |
| Elongation at | 330 | 420 | 630 | 450 | 490 | 590 | 800 | 780 | 420 | 470 | 490 | 190 |
| break [%] | | | | | | | | | | | | |
| Modulus of | 2.1 | 2.5 | 2.0 | 2.3 | 1.9 | 1.7 | 1.6 | 1.5 | 2.0 | 2.3 | 2.3 | 3.2 |
| elasticity [MPa] | | | | | | | | | | | | |
| Tear strength | 11.0 | 14.6 | 18.1 | 13.2 | 16.8 | 17.3 | 23.9 | 23.3 | 11.0 | 13.5 | 12.9 | 7.3 |
| [N/mm] | | | | | | | | | | | | |

^{a}Diisodecylphthalate (Palatinol ® Z, BASF).
^{b}Vinyl trimethoxysilane (Silquest ® A-171, GE Advanced Materials).

What is claimed is:

1. An organoalkylsilane of formula (I) 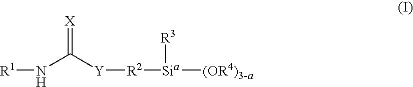
wherein:
R¹ is chosen from substituted and unsubstituted members of the group consisting of alkyl, cycloalkyl, aryl, and arylalkyl groups, which members optionally include one or more heteroatoms, and which members do not include any groups that react with water, silane, amino groups or polymerizable double bonds;
R² is chosen from linear, branched and cyclic alkylene groups with 1 to 20 C atoms, which alkylene groups optionally include one or more aromatic moieties and optionally include one or more heteroatoms;
R³ is chosen from alkyl groups with 1 to 8 C atoms;
R⁴ is chosen from alkyl groups with 1 to 5 C atoms;
a represents 0 or 1 or 2;
X represents O or S;
Y represents O, S or N—R⁵;
wherein:
R⁵ is chosen from linear and branched hydrocarbon residues having 1 to 20 C atoms, which optionally include cyclic moieties, and which optionally include at least one functional group chosen from the group consisting of alkoxysilyl, ether, sulfone, nitrile, nitro, carboxylic acid ester, sulfonic acid ester, and phosphonic acid ester groups.

2. The organoalkoxysilane according to claim 1, wherein a represents 0 or 1.

3. The organoalkoxysilane according to claim 1, wherein R³ is chosen from methyl and ethyl groups.

4. The organoalkoxysilane according to claim 3, wherein R³ is a methyl group.

5. The organoalkoxysilane according to claim 1, wherein R⁴ is chosen from methyl, ethyl and isopropyl groups.

6. The organoalkoxysilane according to claim 5, wherein R⁴ is chosen from methyl and ethyl groups.

7. The organoalkoxysilane according to claim 1, wherein Y represents N—R⁵.

8. The organoalkoxysilane according to claim 7, wherein R⁵ is chosen from methyl groups, ethyl groups, butyl groups, cyclohexyl groups, phenyl groups and residues of formula (III): 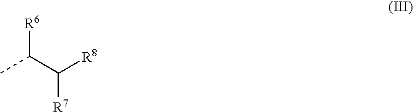
wherein:
R⁶ and R⁷ each independently are chosen from the group consisting of hydrogen atoms and residues of members of the group consisting of R⁹, —COOR⁹, and —CN; and
R⁸ is chosen from the group consisting of hydrogen atoms and residues of members of the group consisting of —CH₂—COOR⁹, —COOR⁹, —CN, —NO₂, —PO(OR⁹)₂, —SO₂R⁹, and —SO₂OR⁹;
wherein:
R⁹ is chosen from the group consisting of hydrocarbon residues with 1 to 20 C atoms, which optionally contain at least one heteroatom.

9. The organoalkoxysilane according to claim 7, wherein in formula (III), R⁶ is —COOR⁹, R⁷ is H, R⁸ is —COOR⁹, and R⁹ is chosen from optionally branched alkyl groups with 1 to 8 C atoms.

10. The organoalkoxysilane according to claim 9, wherein the organoalkoxysilane has formula (IV), 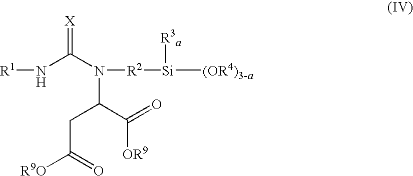
wherein:
R¹ is chosen from the group consisting of ethyl, butyl, cyclohexyl, and phenyl groups;
R² is chosen from the group consisting of methylene, propylene, butylene, methylpropylene, and dimethylbutylene groups; and
R⁹ is chosen from the group consisting of methyl, ethyl, and butyl groups.

11. A method for preparing the organoalkoxysilane according to claim 1, wherein a silane of formula (V) is reacted with a monoisocyanate or a monoisothiocyanate of formula (V), 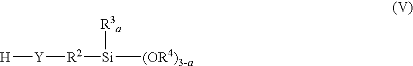
R¹—N═C═X (VI).

12. An adhesion promoter comprising the organoalkoxysilane according to claim 1.

13. A drying agent comprising the organoalkoxysilane according to claim 1.

14. A crosslinker comprising the organoalkoxysilane according to claim 1.

15. A reactive diluent comprising the organoalkoxysilane according to claim 1.

16. A composition comprising at least one organoalkoxysilane according to claim 1.

17. A moisture-curing composition comprising at least one organoalkoxysilane according to claim 1 and at least one polymer chosen from silane-functional polymers and isocyanate-functional polymers.

18. The moisture-curing composition according to claim 17, wherein the polymer is a silane-functional polymer.

19. The moisture-curing composition according to claim 17, wherein the polymer is an isocyanate-functional polyurethane polymer that is obtained by reaction of a polyol with a polyisocyanate.

20. The moisture-curing composition according to claim 17, wherein the polymer is a polyurethane polymer containing both silane and isocyanate groups, which is obtained by reaction of an isocyanate-functional polyurethane polymer with an organoalkoxysilane having an NCO-reactive group, wherein the organoalkoxysilane is used in a substoichiometric amount relative to the isocyanate groups of the polyurethane polymer.

21. The moisture-curing composition according to claim 18, wherein the polymer is a silane-functional polymer, which is obtained by reaction of an isocyanate-functional polyurethane polymer with an organoalkoxysilane having an NCO-reactive group.

22. The moisture-curing composition according to claim 18, wherein the polymer is a silane-functional polymer, which is obtained by reaction of a hydroxyl group-containing polymer with an isocyanate-functional organoalkoxysilane.

23. The moisture-curing composition according to claim 18, wherein the polymer is a silane-functional polymer, which is obtained by a hydrolysis reaction of a polymer with terminal double bonds.

24. The moisture-curing composition according to claim 20, wherein the organoalkoxysilane having an NCO-reactive group is an aminosilane.

25. The moisture-curing composition according to claim 24, wherein the aminosilane has formula (VII), 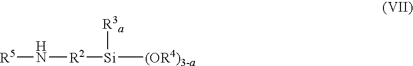
wherein:
R² is chosen from linear, branched and cyclic alkylene groups with 1 to 20 C atoms, which alkylene groups optionally include one or more aromatic moieties and optionally include one or more heteroatoms;
R³ is chosen from alkyl groups with 1 to 8 C atoms;
R⁴ is chosen from alkyl groups with 1 to 5 C atoms;
R⁵ is chosen from linear and branched hydrocarbon residues having 1 to 20 C atoms, which optionally include cyclic moieties, and which optionally include at least one functional group chosen from the group consisting of alkoxysilyl, ether, sulfone, nitrile, nitro, carboxylic acid ester, sulfonic acid ester, and phosphonic acid ester groups; and
a represents 0, 1 or 2.

26. The moisture-curing composition according to claim 25, wherein a represents 0 or 1.

27. The moisture-curing composition according to claim 25, wherein in the aminosilane of formula (VII), R³ is chosen from methyl and ethyl groups, and R⁴ is chosen from methyl, ethyl and isopropyl groups.

28. The moisture-curing composition according to claim 27, wherein in the aminosilane of formula (VII), R³ is a methyl group.

29. The moisture-curing composition according to claim 27, wherein in the aminosilane of formula (VII), R⁴ is chosen from methyl and ethyl groups.

30. The moisture-curing composition according to claim 25, wherein in the aminosilane of formula (VII), R⁵ is chosen from methyl groups, ethyl groups, butyl groups, cyclohexyl groups, phenyl groups and residues of formula (III), 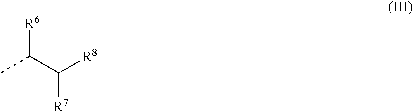
wherein:
R⁶ and R⁷ each independently are chosen from the group consisting of hydrogen atoms and residues of members of the group consisting of R⁹, —COOR⁹, and —CN; and
R⁸ is chosen from the group consisting of hydrogen atoms and residues of members of the group consisting of —CH₂—COOR⁹, —COOR⁹, —CN, —NO₂, —PO(OR⁹)₂, —SO₂R⁹, and —SO₂OR⁹;
wherein:
R⁹ is chosen from the group consisting of hydrocarbon residues with 1 to 20 C atoms, which optionally contain at least one heteroatom.

31. The moisture-curing composition according to claim 30, wherein in formula (III), R⁶ is —COOR⁹, R⁷ is H, R⁸ is —COOR⁹, and R⁹ is chosen from optionally branched alkyl groups with 1 to 8 C atoms.

32. The moisture-curing composition according to claim 17, wherein the organoalkoxysilane is present in an amount of 0.5-40 wt. % relative to the total weight of the polymer.

33. The moisture-curing composition according to claim 32, wherein the organoalkoxysilane is present in an amount of 2-30 wt. % relative to the total weight of the polymer.

34. The moisture-curing composition according to claim 32, wherein the organoalkoxysilane is present in an amount of 4-20 wt. % relative to the total weight of the polymer.

35. An adhesive comprising the composition according to claim 16.

36. A sealant comprising the composition according to claim 16.

37. A paint comprising the composition according to claim 16.

38. A lacquer comprising the composition according to claim 16.

39. A primer comprising the composition according to claim 16.

40. A seal comprising the composition according to claim 16.

41. A protective coating comprising the composition according to claim 16.

42. A floor covering comprising the composition according to claim 16.

43. A bonded article comprising a first substrate and a second substrate that are bonded using the composition according to claim 16, wherein the first substrate and the second substrate are made of different or identical materials.

44. The bonded article according to claim 43, wherein the article is a means of transport.

45. The bonded article according to claim 43, wherein the bonded article is a land or water vehicle.

46. The bonded article according to claim 43, wherein the bonded article is an automobile, a bus, a freight vehicle, a train, or a ship, or a portion thereof.

47. A sealed article comprising a first substrate and a second substrate, wherein the composition according to claim 16 is applied between a surface of the first substrate and a surface of the second substrate to form the sealed article, and the first substrate and the second substrate are made of different or identical materials.

48. A sealed article according to claim 47, wherein the sealed article is a means of transport or a structure.
